(19) United States
(12) Patent Application Publication
(10) Pub. No.: US 2026/0073003 A1
(43) Pub. Date: Mar. 12, 2026

(54) WEB FRAMEWORK WITH WEB WORKERS FOR EXPEDITED LOADING AND OPERATIONS OUTSIDE A USER INTERFACE

(71) Applicant: Microsoft Technology Licensing, LLC, Redmond, WA (US)

(72) Inventors: Siddharth GULATI, Kirkland, WA (US); Ryan NAKHOUL, Redmond, WA (US); Aninda RAY, Sammamish, WA (US); Dennis MYREN, Seattle, WA (US); Patrick Carl MILLER, Sammamish, WA (US)

(73) Assignee: Microsoft Technology Licensing, LLC, Redmond, WA (US)

(21) Appl. No.: 18/830,719

(22) Filed: Sep. 11, 2024

(51) Int. Cl. G06F 16/957; G06F 9/48

(52) U.S. Cl. CPC G06F 16/9574; G06F 9/4881

(57) ABSTRACT

A device includes a processor and a memory storing executable instructions which, when executed by the processor, causes the processor, alone or in combination with other processors, to perform the following functions: in a browser environment, initiate a web application on a main thread; while the web application is launching, with a web worker having a separate, worker thread, retrieve data for the application from a server environment; store the retrieved data with the web worker in an indexedDB; and provide the data from the indexedDB to the web application when the web application is ready for the data so as to decrease an amount of time for the web application to launch.

### BACKGROUND

A web browser is a software application designed to access, retrieve, and display content on the World Wide Web. When a user inputs a web address or clicks on a link, the browser sends a request to the server hosting the website. The server responds by sending the necessary files or data back to the browser, which then interprets and renders these files into the web pages users see. Browsers support a variety of web technologies and protocols, including Hyper-Text Markup Language (HTML), Cascading Style Sheets (CSS), and JavaScript, allowing for the presentation of text, images, videos, and interactive elements. Key features of web browsers include navigation tools like back and forward buttons, bookmarking for easy access to favorite sites, tabbed browsing to open multiple pages simultaneously, and privacy modes to protect user data.

A web application is a software program that runs on a web server and can be accessed through a web browser over the internet or an intranet. Unlike traditional desktop applications, which are installed locally on a user's computer, web applications are hosted on remote servers, and users interact with them via web browsers. Web applications are designed to perform specific tasks and provide various services to users. They range from simple applications like contact forms or online calculators to complex systems like online banking platforms, social media networks, and e-commerce sites. One of the primary advantages of web applications is their accessibility; they can be used on any device with internet access and a web browser, regardless of the operating system. This means users can access their data and functionalities from desktops, laptops, tablets, or smartphones without the need for multiple versions of the software. Additionally, web applications are easier to update and maintain since changes are applied on the server side and instantly available to all users.

### SUMMARY

In one general aspect, the following description presents a device including a processor and a memory storing executable instructions which, when executed by the processor, causes the processor, alone or in combination with other processors, to perform the following functions: in a browser environment, initiate a web application on a main thread; while the web application is launching, with a web worker having a separate, worker thread, retrieve data for the application from a server environment; store the retrieved data with the web worker in an indexedDB; and provide the data from the indexedDB to the web application when the web application is ready for the data so as to decrease an amount of time for the web application to launch.

In another general aspect, the following description presents a device including a processor, and a memory storing executable instructions which, when executed by the processor, causes the processor, alone or in combination with other processors, to perform the following functions: in a browser environment, receive using input via a user interface (UI) to load a web page on a main thread of a browser; execute a web worker having a separate, worker thread during loading of the web page; with the web worker on the worker thread, retrieve data for the web page from a server via a network; with the worker thread, store the retrieved data in local storage while the web page is loading; and provide the data from the local storage to the browser on the main thread when the browser is ready for the data so as to decrease an amount of time for the browser to render the web page.

In yet another general aspect, the following description presents a method for decreasing an amount of time for a web application to launch, the method including: receiving user input, in a browser environment, to initiate the web application on a main thread; commencing download and execution of JavaScript for the web application using the main thread and starting a web worker on a separate worker thread; while the web application is loading, retrieving data for the application from a server environment with the web worker on the worker thread; storing the retrieved data local to the browser environment; and providing the retrieved data from local storage to the web application when the web application is ready for the data.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 illustrates a flowchart for utilizing a web worker and web worker thread to optimize operation of a webpage or web application in a browser according to principles described herein.

FIG. 2 illustrates a system for utilizing a web worker and web worker thread to optimize operation, particularly loading, of a webpage or web application in a browser according to principles described herein.

FIG. 3 illustrates a system with a reusable architecture that is capable of serving multiple scenarios on a shared web worker thread according to principles described herein.

FIG. 4 illustrates additional details of the system in FIG. 3.

FIG. 5 illustrates a specific example of the system of FIG. 3 with a telemetry handler and data retrieval handler.

FIG. 6 is a flowchart of an example method of decreasing an amount of time for a web application to launch using the principles described.

FIG. 7 is a block diagram illustrating an example software architecture, various portions of which may be used in conjunction with various hardware architectures herein described.

FIG. 8 is a block diagram illustrating components of an example machine configured to read instructions from a machine-readable medium and perform any of the features described herein.

### DETAILED DESCRIPTION

JavaScript for a web page or web application runs in a main thread of the web browser. This main thread is also responsible for handling user interactions, rendering the page or pixel painting, and executing other scripts. This means that, if a JavaScript code is performing a computationally intensive task, this will occupy the main thread and can slow down the responsiveness of the page or even freeze the page. Additionally, whether simply displaying a webpage or supporting a web application of the page, a browser has to fetch data from the remote server that supports the webpage or application. Making such network data calls requires time and processing resources that can further slow down the responsiveness of the page. The typical approach in a web application is to load a control, make a data fetch for the control and then render the results. To expedite this, all data fetches should be initiated as soon as possible but are tied to current availability/operation of the main thread.

A web worker is a browser technology that allows JavaScript to run in a background thread that is separate from the main thread. When properly utilized, a worker thread can take on non-User Interface (UI) tasks, particularly those that require significant time or processing resources. This thereby frees up the main thread to better handle user interactions and paint cycles. However, worker threads do have a per-instance memory and start-up cost. This necessitates proper management of the number of active workers. Consequently, a web framework for utilizing web workers in an optimized fashion is needed.

To address the technical problems involved in optimizing the use of web workers, the web framework described should be and is usable with any application and extensible. This allows developers to run any tasks, i.e., non-UI scenarios, in the background on the thread of a web worker. Examples of scenarios that the web worker could handle include, but are not limited to, telemetry, managing an indexed database and data prefetching. For example, the web worker (and thus a data fetch) can be initiated before the corresponding application loads. Also, the processing of tasks handled by the web worker is not blocked behind the application's use of the main thread.

For example, to address the perennial technical problem of a web page taking time to load and become responsive to the user, the web worker can be launched before the boot up of the application. This sequence and relative timing of actions provides a technical solution to the problem of latency in loading the page. As soon as a web worker is up and running, requests are made from the worker thread to prefetch data for the application. Given that the worker is on another thread, the main thread is not blocked. As soon as the data is fetched, the web-worker relays the data to the main thread via a post-messaging mechanism. On the main thread, the application receives the data and utilizes it accordingly. The data is also cached in the indexed database (indexedDB) for future use.

IndexedDB is a low-level Application Programming Interface (API) for client-side storage of significant amounts of structured data, including files, in a web-based application. The indexedDB allows developers to create applications that can work offline and handle large amounts of data, which is particularly useful for complex applications like those involving large datasets, file storage, or extensive user interaction.

Specifically, indexedDB allows the storage of large volumes of data, far exceeding the limits of other web storage options like cookies or localStorage. This makes it suitable for applications that need to cache large amounts of data for offline use. Operations in IndexedDB are asynchronous, meaning they do not block the main thread of the web application. This technical solution of using IndexedDB to store data retrieved by the web worker helps in maintaining a responsive user interface while performing data storage and retrieval tasks. Instead of tables (as in traditional databases), IndexedDB uses object stores to hold data. Each object store contains records with a key and corresponding value. The keys are unique within an object store, ensuring data can be efficiently retrieved. All read and write operations in IndexedDB occur within transactions. This ensures data integrity and consistency, as transactions allow for atomic operations—either all operations within a transaction succeed, or none do. IndexedDB supports the creation of indexes on object stores. Indexes make it easy to search and retrieve data based on different attributes, significantly improving query performance. IndexedDB can store complex data structures, including JavaScript objects, arrays, and other nested structures. This flexibility allows for more sophisticated data handling compared to simple key-value storage. IndexedDB is supported by most modern web browsers.

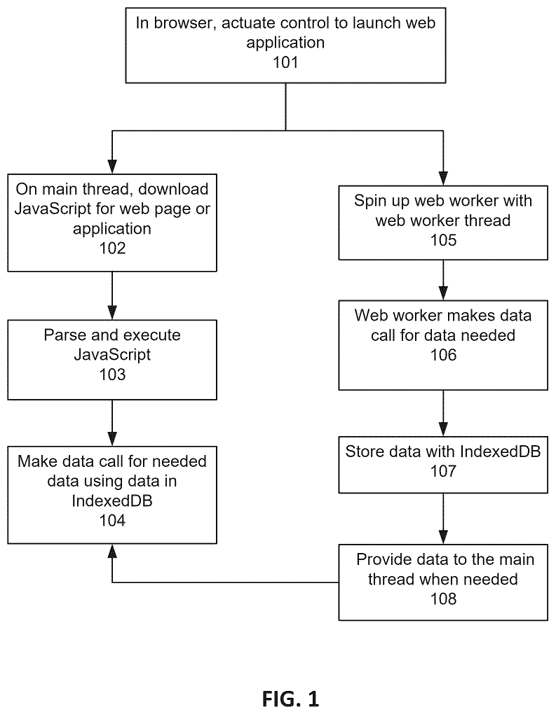

FIG. 1 illustrates a flowchart for utilizing a web worker and web worker thread to optimize operation of a webpage or web application in a browser according to principles described herein. As shown in FIG. 1, the illustrated example begins with the user operating a browser. Within the browser, the user actuates a control 101. This could be, for example, a link to access a webpage or a button to launch a web application.

As shown in FIG. 1, two processes can then occur in parallel. On the left, using the main thread, the browser downloads 102 the JavaScript for the web page or web application from a server environment where the web page or application is supported. The JavaScript is then parsed and executed 103. Eventually, the browser will need to make a data call for the data needed to render the web page or for the web application to operate. Traditionally, this has meant making another data call to the server environment for the needed data. Time is required for downloading and executing the JavaScript. Additional time is required for the data call to the server environment for any needed data.

However, after actuation of the control 101, and concurrent with downloading the JavaScript from the server environment, the process on the right side is executed. This begins with spinning up a web worker on a separate web worker thread 105. The web worker promptly makes the data call 106 for the data that the web page needs to render or that the web application will need to operate. This data is received by the web worker and is stored with IndexedDB 107.

Consequently, as soon as the main thread is ready for the data to support the web page or web application, the browser makes a data call 104 for the needed data from the Inedexed DB. This data is then provided 108 to the browser. In essence, the data call becomes a local call for the browser rather than a call to the server environment. This provides the technical advantage of using a local data call which takes substantially less time than a remote call to a server environment.

Specifically, in the web worker framework being described, Last Known Good Data (LKG) is fetched from the server and flushed down the HTML. As indicated, reading the data from indexedDB (client-side storage) is essentially a local fetch. Hence, if the LKG data is stored in the indexedDB, and if the indexedDB operations are managed by the web worker thread, then as soon as the web worker is up and running, it can quickly check if there is LKG data in the indexedDB. If so, the LKG data is sent back to the main thread where this data can be used by the client. If not, the LKG data can be called from the server environment by the web worker. By storing the LKG data in the indexedDB, it is almost always guaranteed that LKG data will be there for client-side components (like webparts) when requested. This results in faster rendering and performance improvements.

To implement the flow described above, there three adjustments are made. (1) The inline script on the web page is adjusted. At launch the web worker initialization code is changed to launch the web worker as soon as possible with information to know what web application is running and to set the page up to interact with the web worker on behalf of the application. (2) The web worker is updated to handle the data access/caching/etc., as described herein. (3) The application is adjusted to leverage the updated data access model, e.g., to pull data from IndexedDB rather than a call to a remote data store.

Web workers need to be launched from the same domain on which the page is hosted. Consequently, the web worker cannot be simply pointed at the JavaScript code because it is hosted on a content delivery network (CDN). Instead, inline script is encoded into a blob and passed to the worker. A blob is a “Binary Large Object.” It is a data type that represents a file-like object of immutable, raw data. Blobs are used to store and manipulate binary data in web applications, which can include text, images, audio, video, and other multimedia content. Blobs can be passed to web workers through the postMessage method. This allows the web worker to handle large data objects without blocking the main thread. Web workers can also generate and send blobs back to the main thread, which can then be used for various purposes like file downloads or further processing.

For example, the script to execute a web application may reference an ashx file. Knowing the contents of the ashx file, the blob can be configured to reference the ashx file directly. This essentially unwinds the result of the ashx request and puts the response in the blob directly.

Next, state can be passed to the worker in the blob. Whatever is encoded in the blob is accessible by the worker. As such, for example, variables can be added such as appId and hostUrl, so that the worker knows what application is running and what the full Universal Resource Locator (URL) is. This is useful because it does not require any communication between the worker and the main page.

As mentioned, it is desirable to get the web worker running as soon as possible so that it can start fetching data. Inlining the source of the worker.js file helps expedite this. For example, at about 190 ms the web worker starts up and is decoding the blob. The blob directs the web worker where to get its starting code, and at 393 ms the blob returns with direction on where to get the actual web worker file. By encoding the location of the web worker in the original blob, the process can skip that entire request for the ashx file and save time (e.g., about 200 ms in this example, likely more on slower connections).

Next, with dependency on the ashx file avoided, the web worker actually starts. However, the browser will wait until the end of a long task caused by the compilation of the application assembly before actually starting the worker thread. This delay may be about 100 ms or longer on slower machines where there is no code cache, etc. Consequently, it would be advantageous to let the worker spawn before the long task of loading the application assembly. To achieve this, the process will:
1. Preload the application script so that it is on the local machine.
2. Create a ScriptLoaded promise object that will indicate that the script has loaded.
3. In the blob that launches the web worker, have it immediately post a message back to the main thread stating “web worker started” and then load the actual worker JavaScript file.
4. Create a timeout that will load the JavaScript code after a given time period (e.g., 50 ms) in case something goes wrong.
5. When the main thread receives the “web worker started” message (or the timeout fires), load the assembly JavaScript for the application.
6. In the script tag that loads the application assembly, have the onload event for the script signal that the ScriptLoaded promise has been resolved
7. The spfx-start code waits for the ScriptLoaded promise to be resolved, then starts the application.

In this way, the thread is still fully utilized. The usual random assortment of tasks gets created during page startup. Moreover, the following objectives are achieved.
1. The blob is created and the worker is created.
2. The worker decodes the blob and executes it. One of the first lines posts back to the main thread saying the worker has started.
3. The blob code directs loading of the web worker JavaScript.
4. The main thread work queue can receive the message from the worker saying it has loaded. A marker out is written at that point. A script tag is written to parse/evaluate the application assembly, which gets added to the queue. When the browser has time on the main thread, it will eval/compile the application assembly.
5. In the meantime, the web worker has loaded its'code and is executing. It then makes some network requests to get data, e.g. frequent and followed sites, for the application.
6. The browser is free to compile the script. At the end of the compile phase, the browser signals the StartSPFx promise, saying it is ready to execute.
7. The application starts running.

Advantageously, with this approach, the web worker is executing and making network calls before compilation of the application starts. This is achieved with very minimal impact on the application, e.g., 10-15 ms.

The messaging between the application and the web worker will now be described. Traditionally, the web worker is used when the application posts a message, and the worker responds (if needed). There is a web worker proxy that manages these messages and effectively “returns” the response to the caller. While this mechanism can still be used on occasion, it is not used as the primary method of communication between the application and web worker for two reasons. First, the data fetch by the web worker should be somewhat autonomous, fetching data based on the application (or possibly the URL) which is available at time 0, rather than waiting to have the application compiled, executed and sending messages. Second, the first message likely sent to the web worker is a notification that the application has finished the token->cookie exchange. Consequently, it is then assured that network calls can be made. As described herein, however, that message is to be triggered as soon as possible and waiting for the application (which has the code needed to talk to the proxy) to be running is sub-optimal. Furthermore, messages like “you're authenticated” or “here's a token” do not need a response.

For the most part, the data comes in a stream, and the application deals with the data as received. However, it is possible that the data is ready before the application even loads. Consequently, the inline JavaScript needs to address this. First, the script needs to store any data messages that are delivered before the application starts. Then, the script needs to deliver those messages to the application once it is ready. Consequently, a callback is used that the application can populate. If that callback exists, any message received is passed to it. If the callback is not populated, a message received is put in an array for the application to access once it has loaded. Since all messages come from the worker, it is useful to differentiate between them, i.e., is this an app data message or one of the other handlers. For messages to get to the callback/array, each message needs to be associated with the application identification (ID).

Since the application ID is passed to the worker, the worker will be able to asynchronously load the particular app handler at startup. This will allow each app to opt-in, and manage its code separately. Preferably, the data code is small.

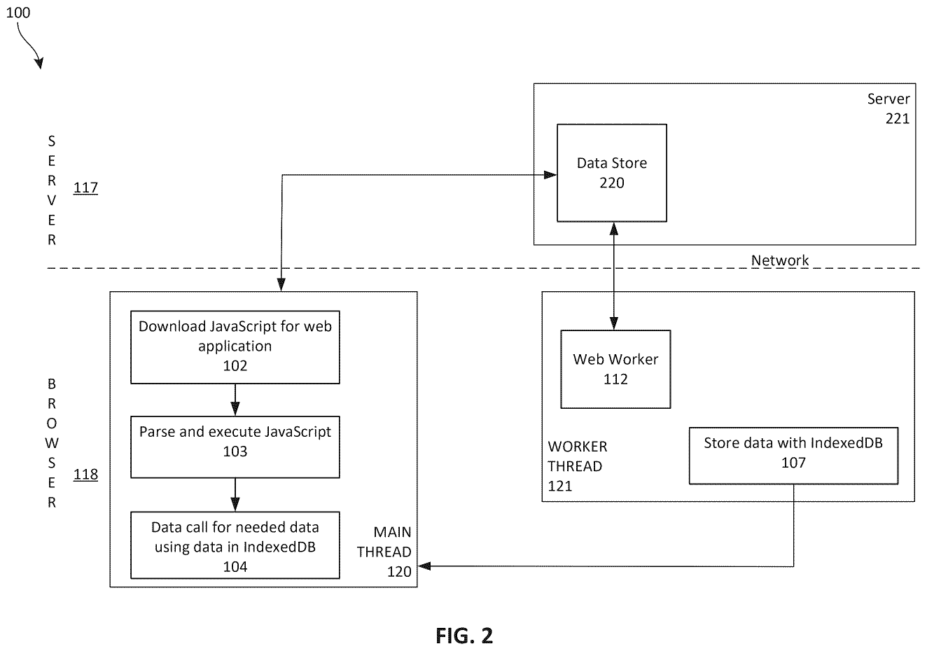

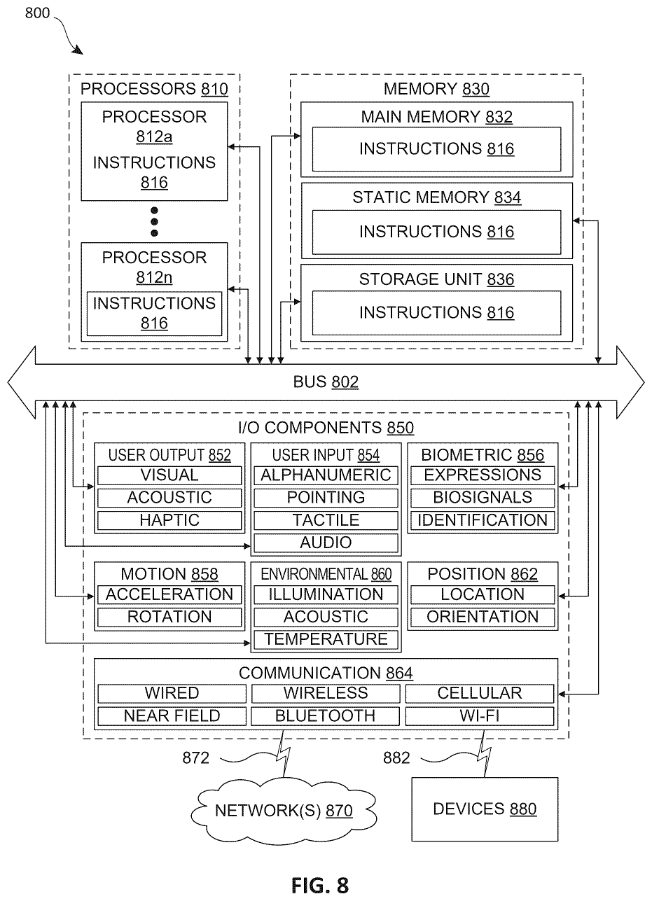

FIG. 2 illustrates a system for utilizing a web worker and web worker thread to optimize operation, particularly loading, of a webpage or web application in a browser according to principles described herein. As shown in FIG. 2, a browser or client-side environment 118 is supported on a computer, for example, such as the computer illustrated in FIG. 8. Using a data network, such as the Internet, the browser environment communicates with a server or server environment 117 remote from the browser environment 118.

As explained above in connection with FIG. 1, a main processing thread 120 in the browser environment responds to a command to launch a web application by downloading the JavaScript for the web application 102 and parsing/executing the JavaScript 103. The JavaScript is downloaded from a data store 220 of a server 221 in a server environment 117 remote from the browser environment 118. Eventually, when ready, a data call 104 is made from the main thread 120 for the data needed for operating the web application.

Meanwhile, a web worker 112 has been executing on a separate worker thread 121. As described in connection with FIG. 1, the web worker 112 accesses the data store 220 in the server environment 117 and loads the data that will be needed by the main thread 120 to operate the web application (or to render a web page). The worker thread 121 will store the data with IndexedDB 107. Consequently, when the data call 104 is made, the data is available locally from the IndexedDB rather than having to load remotely from the data store 220 in the server environment 117.

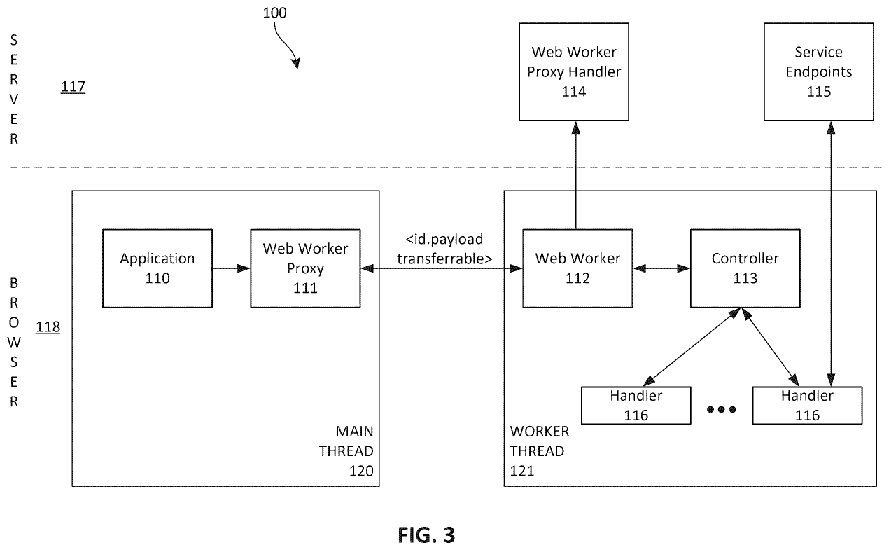

In further detail, FIG. 3 illustrates a system with a reusable architecture that is capable of serving multiple scenarios on a shared web worker thread according to principles described herein. As shown in FIG. 3, the browser environment 118 hosts a web-based application 110 and a web worker proxy 111. The web application 110 and web worker proxy 111 execute on the main processing thread 120. Specifically, the web worker proxy 111 runs on the main thread 120 and manages communication between the application 110 on the main thread 120 and a separate worker thread 121.

A web worker 112 and its controller 113 run on the worker thread 121. A web worker proxy handler 114 is a server environment 117 endpoint that abstracts all JavaScript code needed to start the worker thread 121.

The controller 113 orchestrates incoming requests and passes them to their corresponding handlers 116. Each of the handlers 116 run on the worker thread 121 and is responsible for serving a dedicated task or scenario. For example, the scenario of one handler may be collecting telemetry on the operation of the web-based application or any of its processes. The task/scenario could also be the IndexedDB, which can be offloaded to the web worker rather than running on the main thread 120.

As shown in FIG. 3, a handler 116 for downloading the data that the application 110 will need can be in communication with service endpoints 115 in the server environment 117 for the application. This will give that handler 116 access to the data store in the server environment 117 from which the needed data can be fetched.

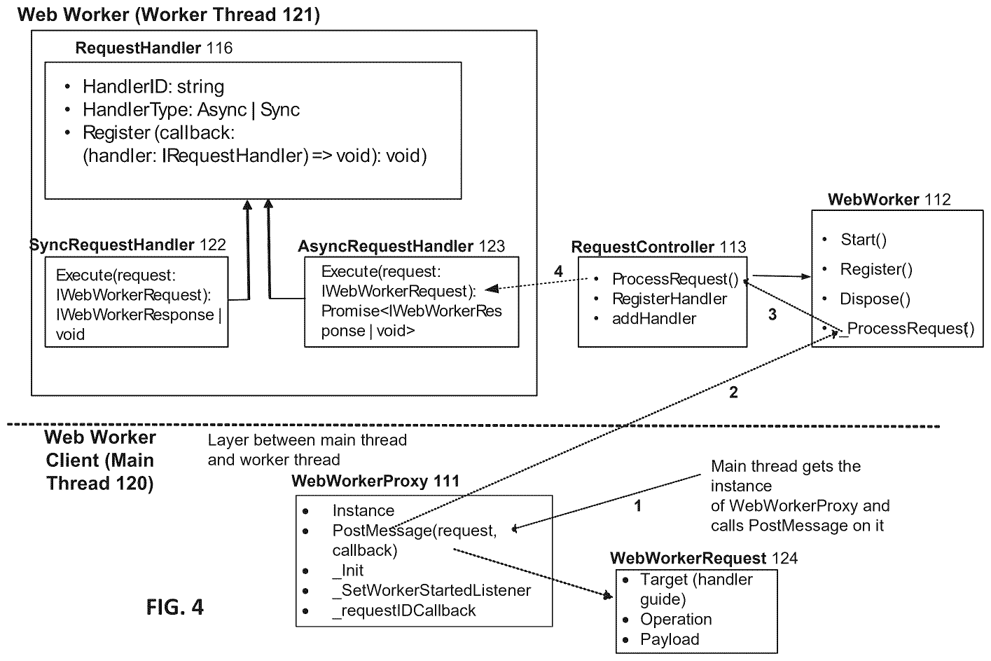

FIG. 4 illustrates additional details of the system in FIG. 3. As shown in FIG. 4, the worker thread 121 supports the web worker 112, controller 113 (also referred to as a request controller) and handler 116 (also referred to as a request handler). A web worker client that includes the web worker proxy 11 executes on the main thread 120.

As shown, (1) the main thread 120 gets an instance of the web worker proxy 111 and calls PostMessage on the proxy. The proxy 111 then issues a web worker request 124 to the web worker 112.

In general, the web worker 112 will start, register, dispose and be ready to process a request when received from the proxy 111. The request will be passed to the request controller 113. The controller 113 will assign the request to an appropriate request handler 116. As described in connection with FIG. 3, each handler 116 may be dedicated to a particular scenario. For example, one handler can be configured to handle IndexedDB. Another handler might be configured to fetch data that will be needed by a web application on the main thread. Another handler might be configured to manage telemetry for a web application, as described below.

A request handler 116 can operate as synchronous request handler 122 or an asynchronous request handler 123. An asynchronous request handler 123 can provide an asynchronous data push from the web worker to the application.

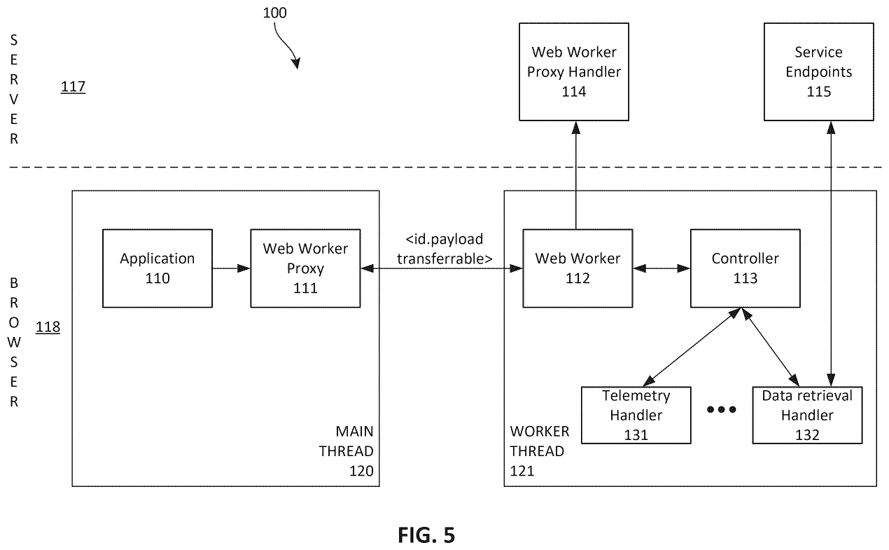

FIG. 5 illustrates a specific example of the system of FIG. 3 with a telemetry handler and data retrieval handler. As described above in detail, one of the tasks performed by the web worker 112 may be early fetching of data that will be needed by the main thread for a webpage render or web application. Accordingly, the worker thread 121 may have a data retrieval handler 132 dedicated to that task.

Another of the tasks that can be offloaded to the web worker and worker thread may be handling telemetry. Telemetry in a web application refers to the automated process of collecting, transmitting, and analyzing data about the application's performance and user interactions. This data includes metrics such as how quickly pages load, error rates, and how users navigate through the site. The information is sent from the user's browser or server to a central system where it is analyzed to monitor the application's health, diagnose issues, and understand user behavior. By continuously gathering and examining this data, developers can identify and fix problems, optimize performance, and improve the overall user experience. For example, telemetry can help pinpoint slow-loading pages or frequent errors, allowing developers to address these issues more effectively. Additionally, it aids in ensuring compliance with regulations and enhancing security by detecting unusual activity patterns.

Traditionally, the task of onboarding telemetry is handled on the main thread. This includes packaging the collected telemetry data into a structured format for transmission and analysis. However, this task can be assigned to a telemetry handler 131 on the worker thread 121. A long running task (LRT) results from telemetry events being packaged right before being sent to the server environment 117. In an example, this LRT may take 102.65 ms to complete. Consequently, by moving this work to the worker thread 121, the operation of the main thread 120 is expedited by that amount of time. For example, a first Central Processing Unit (CPU) idle time (FCI) may be reduced by the amount of time the LRT would take if running on the main thread.

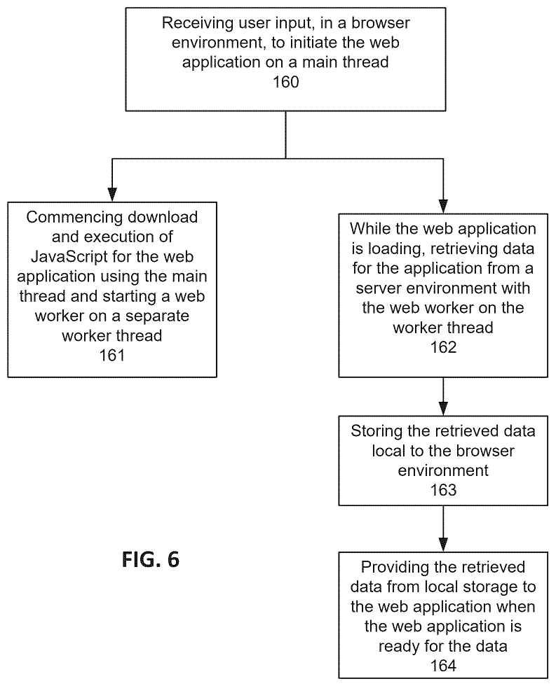

To summarize, FIG. 6 is a flowchart of an example method of decreasing an amount of time for a web application to launch using the principles described. As shown in FIG. 6, a method for decreasing an amount of time for a web application to launch, the method includes: receiving user input, in a browser environment, to initiate the web application on a main thread 160; commencing download and execution of JavaScript for the web application using the main thread and starting a web worker on a separate worker thread 161; while the web application is loading, retrieving data for the application from a server environment with the web worker on the worker thread 162; storing the retrieved data local to the browser environment 163; and providing the retrieved data from local storage to the web application when the web application is ready for the data 164.

Principles for the web framework for optimized use of web workers include the following.
(1) Ensure the web worker thread is available as soon as possible at the start of the navigation lifecycle in the browser to enable the application to leverage the web worker immediately. Through optimizations in the server page handlers and the service worker (when available) we ensured that the web worker thread is started as early as possible.
(2) Implement a reusable architecture that is application and framework agnostic to make it easy to onboard any scenario of tasks to be handled by the web worker.
(3) Support multiple scenarios on a single web worker to avoid the cost of managing multiple threads.
(4) Persist the worker thread across a user session to make it available across applications.

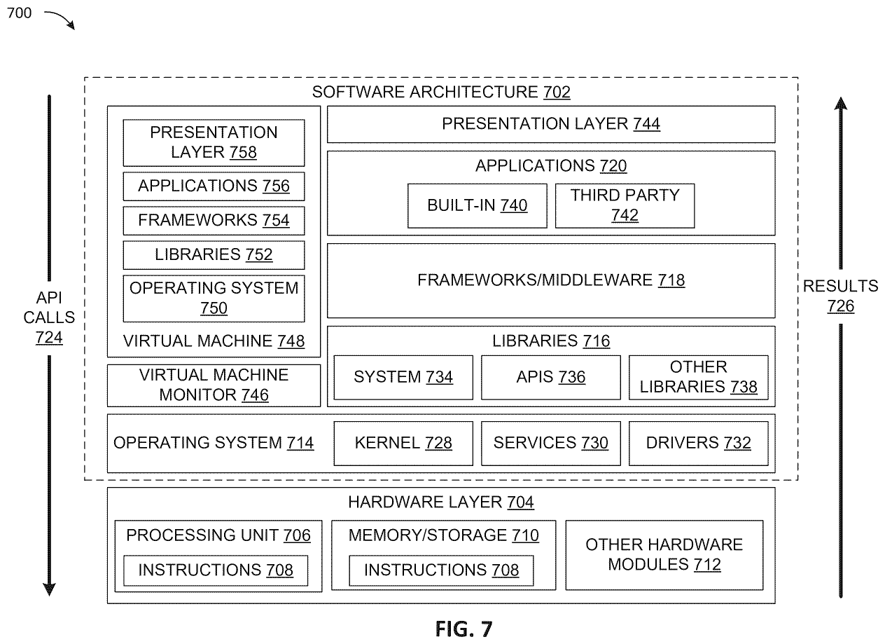

FIG. 7 is a block diagram 700 illustrating an example software architecture 702, various portions of which may be used in conjunction with various hardware architectures herein described, which may implement any of the above-described features. FIG. 7 is a non-limiting example of a software architecture, and it will be appreciated that many other architectures may be implemented to facilitate the functionality described herein. The software architecture 702 may execute on hardware such as a machine 800 of FIG. 8 that includes, among other things, processors 810, memory 830, and input/output (I/O) components 850. A representative hardware layer 704 is illustrated and can represent, for example, the machine 800 of FIG. 8. The representative hardware layer 704 includes a processing unit 706 and associated executable instructions 708. The executable instructions 708 represent executable instructions of the software architecture 702, including implementation of the methods, modules and so forth described herein. The hardware layer 704 also includes a memory/storage 710, which also includes the executable instructions 708 and accompanying data. The hardware layer 704 may also include other hardware modules 712. Instructions 708 held by processing unit 706 may be portions of instructions 708 held by the memory/storage 710.

The example software architecture 702 may be conceptualized as layers, each providing various functionality. For example, the software architecture 702 may include layers and components such as an operating system (OS) 714, libraries 716, frameworks 718, applications 720, and a presentation layer 744. Operationally, the applications 720 and/or other components within the layers may invoke API calls 724 to other layers and receive corresponding results 726. The layers illustrated are representative in nature and other software architectures may include additional or different layers. For example, some mobile or special purpose operating systems may not provide the frameworks/middleware 718.

The OS 714 may manage hardware resources and provide common services. The OS 714 may include, for example, a kernel 728, services 730, and drivers 732. The kernel 728 may act as an abstraction layer between the hardware layer 704 and other software layers. For example, the kernel 728 may be responsible for memory management, processor management (for example, scheduling), component management, networking, security settings, and so on. The services 730 may provide other common services for the other software layers. The drivers 732 may be responsible for controlling or interfacing with the underlying hardware layer 704. For instance, the drivers 732 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 716 may provide a common infrastructure that may be used by the applications 720 and/or other components and/or layers. The libraries 716 typically provide functionality for use by other software modules to perform tasks, rather than rather than interacting directly with the OS 714. The libraries 716 may include system libraries 734 (for example, C standard library) that may provide functions such as memory allocation, string manipulation, file operations. In addition, the libraries 716 may include API libraries 736 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 716 may also include a wide variety of other libraries 738 to provide many functions for applications 720 and other software modules.

The frameworks 718 (also sometimes referred to as middleware) provide a higher-level common infrastructure that may be used by the applications 720 and/or other software modules. For example, the frameworks 718 may provide various graphic user interface (GUI) functions, high-level resource management, or high-level location services. The frameworks 718 may provide a broad spectrum of other APIs for applications 720 and/or other software modules.

The applications 720 include built-in applications 740 and/or third-party applications 742. Examples of built-in applications 740 may include, but are not limited to, a contacts application, a browser application, a location application, a media application, a messaging application, and/or a game application. Third-party applications 742 may include any applications developed by an entity other than the vendor of the particular platform. The applications 720 may use functions available via OS 714, libraries 716, frameworks 718, and presentation layer 744 to create user interfaces to interact with users.

Some software architectures use virtual machines, as illustrated by a virtual machine 748. The virtual machine 748 provides an execution environment where applications/modules can execute as if they were executing on a hardware machine (such as the machine 800 of FIG. 8, for example). The virtual machine 748 may be hosted by a host OS (for example, OS 714) or hypervisor, and may have a virtual machine monitor 746 which manages operation of the virtual machine 748 and interoperation with the host operating system. A software architecture, which may be different from software architecture 702 outside of the virtual machine, executes within the virtual machine 748 such as an OS 750, libraries 752, frameworks 754, applications 756, and/or a presentation layer 758.

FIG. 8 is a block diagram illustrating components of an example machine 800 configured to read instructions from a machine-readable medium (for example, a machine-readable storage medium) and perform any of the features described herein. The example machine 800 is in the form of a computer system, within which instructions 816 (for example, in the form of software components) for causing the machine 800 to perform any of the features described herein may be executed.

As such, the instructions 816 may be used to implement modules or components described herein. The instructions 816 cause unprogrammed and/or unconfigured machine 800 to operate as a particular machine configured to carry out the described features. The machine 800 may be configured to operate as a standalone device or may be coupled (for example, networked) to other machines. In a networked deployment, the machine 800 may operate in the capacity of a server machine or a client machine in a server-client network environment, or as a node in a peer-to-peer or distributed network environment. Machine 800 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 800 is illustrated, the term “machine” includes a collection of machines that individually or jointly execute the instructions 816.

The machine 800 may include processors 810, memory 830, and I/O components 850, which may be communicatively coupled via, for example, a bus 802. The bus 802 may include multiple buses coupling various elements of machine 800 via various bus technologies and protocols. In an example, the processors 810 (including, for example, a central processing unit (CPU), a graphics processing unit (GPU), a digital signal processor (DSP), an ASIC, or a suitable combination thereof) may include one or more processors 812a to 812n that may execute the instructions 816 and process data. In some examples, one or more processors 810 may execute instructions provided or identified by one or more other processors 810. The term “processor” includes a multi-core processor including cores that may execute instructions contemporaneously. Although FIG. 8 shows multiple processors, the machine 800 may include a single processor with a single core, a single processor with multiple cores (for example, a multi-core processor), multiple processors each with a single core, multiple processors each with multiple cores, or any combination thereof. In some examples, the machine 800 may include multiple processors distributed among multiple machines.

The memory/storage 830 may include a main memory 832, a static memory 834, or other memory, and a storage unit 836, both accessible to the processors 810 such as via the bus 802. The storage unit 836 and memory 832, 834 store instructions 816 embodying any one or more of the functions described herein. The memory/storage 830 may also store temporary, intermediate, and/or long-term data for processors 810. The instructions 816 may also reside, completely or partially, within the memory 832, 834, within the storage unit 836, within at least one of the processors 810 (for example, within a command buffer or cache memory), within memory at least one of I/O components 850, or any suitable combination thereof, during execution thereof. Accordingly, the memory 832, 834, the storage unit 836, memory in processors 810, and memory in I/O components 850 are examples of machine-readable media.

As used herein, “machine-readable medium” refers to a device able to temporarily or permanently store instructions and data that cause machine 800 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 816) for execution by a machine 800 such that the instructions, when executed by one or more processors 810 of the machine 800, cause the machine 800 to perform and one or more of the features described herein. Accordingly, a “machine-readable medium” may refer to a single storage device, as well as “cloud-based” storage systems or storage networks that include multiple storage apparatus or devices. The term “machine-readable medium”excludes signals per se.

The I/O components 850 may include a wide variety of hardware components adapted to receive input, provide output, produce output, transmit information, exchange information, capture measurements, and so on. The specific I/O components 850 included in a particular machine will depend on the type and/or function of the machine. For example, mobile devices such as mobile phones may include a touch input device, whereas a headless server or IoT device may not include such a touch input device. The particular examples of I/O components illustrated in FIG. 8 are in no way limiting, and other types of components may be included in machine 800. The grouping of I/O components 850 are merely for simplifying this discussion, and the grouping is in no way limiting. In various examples, the I/O components 850 may include user output components 852 and user input components 854. User output components 852 may include, for example, display components for displaying information (for example, a liquid crystal display (LCD) or a projector), acoustic components (for example, speakers), haptic components (for example, a vibratory motor or force-feedback device), and/or other signal generators. User input components 854 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 850 may include biometric components 856, motion components 858, environmental components 860, and/or position components 862, among a wide array of other physical sensor components. The biometric components 856 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 858 may include, for example, acceleration sensors (for example, an accelerometer) and rotation sensors (for example, a gyroscope). The environmental components 860 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 862 may include, for example, location sensors (for example, a Global Position System (GPS) receiver), altitude sensors (for example, an air pressure sensor from which altitude may be derived), and/or orientation sensors (for example, magnetometers).

The I/O components 850 may include communication components 864, implementing a wide variety of technologies operable to couple the machine 800 to network(s) 870 and/or device(s) 880 via respective communicative couplings 872 and 882. The communication components 864 may include one or more network interface components or other suitable devices to interface with the network(s) 870. The communication components 864 may include, for example, components adapted to provide wired communication, wireless communication, cellular communication, Near Field Communication (NFC), Bluetooth communication, Wi-Fi, and/or communication via other modalities. The device(s) 880 may include other machines or various peripheral devices (for example, coupled via USB).

In some examples, the communication components 864 may detect identifiers or include components adapted to detect identifiers. For example, the communication components 864 may include Radio Frequency Identification (RFID) tag readers, NFC detectors, optical sensors (for example, one-or multi-dimensional bar codes, or other optical codes), and/or acoustic detectors (for example, microphones to identify tagged audio signals). In some examples, location information may be determined based on information from the communication components 864, such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

Generally, functions described herein (for example, the features illustrated in FIGS. 1-6) can be implemented using software, firmware, hardware (for example, fixed logic, finite state machines, and/or other circuits), or a combination of these implementations. In the case of a software implementation, program code performs specified tasks when executed on a processor (for example, a CPU or CPUs). The program code can be stored in one or more machine-readable memory devices. The features of the techniques described herein are system-independent, meaning that the techniques may be implemented on a variety of computing systems having a variety of processors. For example, implementations may include an entity (for example, software) that causes hardware to perform operations, e.g., processors functional blocks, and so on. For example, a hardware device may include a machine-readable medium that may be configured to maintain instructions that cause the hardware device, including an operating system executed thereon and associated hardware, to perform operations. Thus, the instructions may function to configure an operating system and associated hardware to perform the operations and thereby configure or otherwise adapt a hardware device to perform functions described above. The instructions may be provided by the machine-readable medium through a variety of different configurations to hardware elements that execute the instructions.

In the foregoing detailed description, numerous specific details were set forth by way of examples in order to provide a thorough understanding of the relevant teachings. It will be apparent to persons of ordinary skill, upon reading the description, that various aspects can be practiced without such details. In other instances, well known methods, procedures, components, and/or circuitry have been described at a relatively high-level, without detail, in order to avoid unnecessarily obscuring aspects of the present teachings.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows, and to encompass all structural and functional equivalents.

Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein.

Relational terms such as first and second and the like may be used solely to distinguish one entity or action from another without necessarily requiring or implying any actual such relationship or order between such entities or actions. The terms “comprises,” “comprising,” and any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “a” or “an” does not, without further constraints, preclude the existence of additional identical elements in the process, method, article, or apparatus that comprises the element.

The Abstract of the Disclosure is provided to allow the reader to quickly identify the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that any claim requires more features than the claim expressly recites. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A device comprising:
a processor, and
a memory storing executable instructions which, when executed by the processor, causes the processor, alone or in combination with other processors, to perform the following functions:
in a browser environment, initiate a web application on a main thread;
while the web application is launching, with a web worker having a separate, worker thread, retrieve data for the web application from a server environment;
store the retrieved data with the web worker in an indexedDB; and
provide the data from the indexedDB to the web application when the web application is ready for the data so as to decrease an amount of time for the web application to launch.

2. The device of claim 1, wherein the retrieved data is a Last Known Good (LKG) data for the web application.

3. The device of claim 1, further comprising a web worker proxy on the main thread for the web application to communicate with the web worker on the worker thread.

4. The device of claim 1, further comprising a web worker proxy handler in the server environment with which the web worker communicates with a server in the server environment.

5. The device of claim 1, further comprising a request controller on the worker thread to provide requests received by the web worker to one of a number of request handlers, one of the request handlers being dedicated to retrieving the data for the web application during loading of the web application.

6. The device of claim 5, wherein another request handler is dedicated to collecting telemetry for the web application.

7. The device of claim 5, wherein the number of request handlers comprises a synchronous request handler and an asynchronous request handler.

8. A device comprising:
a processor, and
a memory storing executable instructions which, when executed by the processor, causes the processor, alone or in combination with other processors, to perform the following functions:
in a browser environment, receive using input via a user interface (UI) to load a web page on a main thread of a browser;
execute a web worker having a separate, worker thread during loading of the web page;
with the web worker on the worker thread, retrieve data for the web page from a server via a network;
with the worker thread, store the retrieved data in local storage while the web page is loading; and
provide the data from the local storage to the browser on the main thread when the browser is ready for the data so as to decrease an amount of time for the browser to render the web page.

9. The device of claim 8, wherein storing the retrieved data in local storage comprises storing the retrieved data using indexedDB.

10. The device of claim 8, wherein the web page comprises a web application and loading the web page comprises downloading and executing JavaScript for the web application on the main thread.

11. The device of claim 10, further comprising instructions causing the processor to collect telemetry for the web application using the web worker on the worker thread.

12. The device of claim 8, further comprising a web worker proxy on the main thread for the browser to communicate with the web worker.

13. The device of claim 8, further comprising a web worker proxy handler in the server with which the web worker communicates with the server.

14. The device of claim 8, further comprising a request controller on the worker thread to provide requests received by the web worker to one of a number of request handlers.

15. The device of claim 14, wherein a first request handler is dedicated to collecting telemetry for a web application of the web page.

16. The device of claim 15, wherein a second request handler is dedicated to retrieving the data for the web page during loading of the web page.

17. The device of claim 14, wherein the number of request handlers comprises a synchronous request handler and an asynchronous request handler.

18. A method for decreasing an amount of time for a web application to launch, the method comprising:
receiving user input, in a browser environment, to initiate the web application on a main thread;
commencing download and execution of JavaScript for the web application using the main thread and starting a web worker on a separate worker thread;
while the web application is loading, retrieving data for the application from a server environment with the web worker on the worker thread;
storing the retrieved data local to the browser environment; and
providing the retrieved data from local storage to the web application when the web application is ready for the data.

19. The method of claim 18, further comprising storing the retrieved data locally with IndexedDB.

20. The method of claim 18, further comprising, with the web worker on the worker thread, providing a number of request handlers;
wherein a first request handler is dedicated to retrieving the data from the server environment, and
a second request handler is dedicated to collecting telemetry for the web application.
